(19) United States
(12) Patent Application Publication
(10) Pub. No.: US 2002/0135492 A1
(43) Pub. Date: Sep. 26, 2002

(54) Ultrasonic control and monitoring bus and method

(76) Inventors: Michael Reagan, Palm Coast, FL (US); Virginia Reagan, Palm Coast, FL (US)

Correspondence Address: PERMAN & GREEN, 425 POST ROAD, FAIRFIELD, CT, 06430, US

(21) Appl. No.: 09/815,024

(22) Filed: Mar. 22, 2001

(51) Int. Cl. G10K 11/00; G08C 19/00

(52) U.S. Cl. 340/825.69; 367/197

(57) ABSTRACT

An apparatus has a plurality of power supplies coupled to a common output power bus and a single controller. To avoid ground loops, interference, high cost, and line-of-sight operation, sound waves are used to communicate between the controller and the power supplies. The sound waves are preferably of at least 18 KHz in frequency and preferably FSK modulated with control or data information.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to apparatus and method for communicating and control, and, more particularly, between a controller and a plurality of power supplies connected to a common output power bus.

2. Description of the Related Art Including Information Disclosed Under 37 CFR 1.97 and 1.98

In many applications it is desirable to have a plurality of power supplies coupled to a common output power bus and controlled by a single controller. One way of doing this is to use a plurality of direct electrical control connection wires to couple the controller to each of the respective power supplies for the transmission of data signals from the power supplies to the controller and the transmission of control signals from the controller to the power supplies.

However, this results in several problems. The main one is that of galvanic interaction (“ground loops”) caused by multiple grounding points, which in turn causes spurious signals, e.g., a 50 or 60 Hz power bus frequency signal, to be present on the control wires. These spurious signals can cause erroneous data and/or control signals. Other problems are erroneous signals due to miswiring; and low reliability and high cost due to the use of electrical contacts and fragile wiring. If RF (radio frequency) control is used instead of the control connection wires, the result can be electrical interference due to radiation to and from the wiring. Some of these problems can be solved by using infrared signals in place of the direct connection wiring. However, such control is highly directional, thereby requiring nearly direct line-of-sight operation.

It is therefore desirable to have a control method and apparatus that does not cause ground loops, is not subject to miswiring, does not cause or receive electrical interference, has a high reliability and low cost, and does not require line-of-sight operation.

### BRIEF SUMMARY OF THE INVENTION

A method of communicating between a plurality of power supplies coupled to a common output power bus and a controller comprises transmitting and receiving sound waves between said controller and said power supplies.

An apparatus comprises a plurality of power supplies coupled to a common output power bus; and a controller, each of said power supplies and said controller comprising an interface transmitting and receiving sound waves between said controller and said power supplies for communication therebetween.

### BRIEF DESCRIPTION OF THE SEVERAL VIEWS OF THE DRAWING(S)

FIG. 1 is a block diagram of the invention.

### DETAILED DESCRIPTION OF THE INVENTION

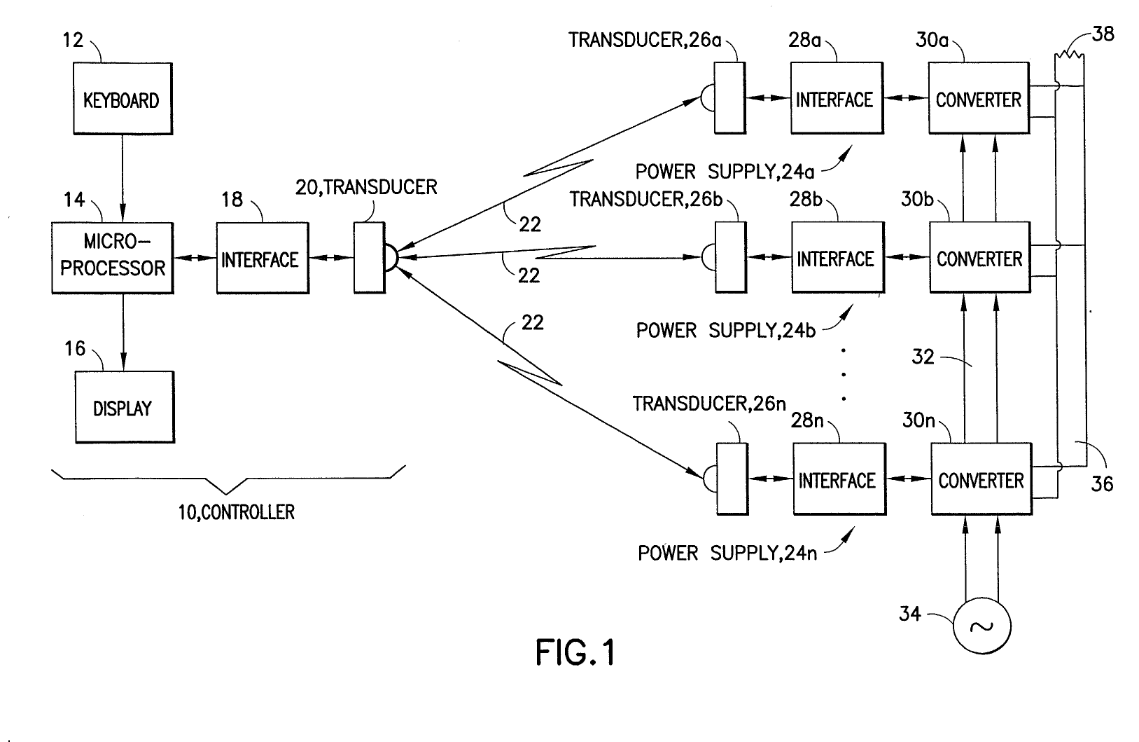

FIG. 1 shows a controller 10, which can either be fixed or mobile, e.g., handheld. It comprises, in general, a data source, such as a keyboard 12, coupled to a microprocessor 14, a data utilizer, such as a display 16, coupled to the microprocessor 14, an interface 18, such as oscillators, modulators, amplifiers and detectors (none shown) and all as known in the art, coupled to microprocessor 18, and a sonic or ultrasonic transducer 20 coupled to interface 18. In a preferred embodiment, interface 18 transmits and receives energy of at least 18 KHz to avoid the audible range, but any desired frequency can be used. Further, frequency shift keying (FSK) modulation is used for noise rejection, but any other analog or digital modulation type, e.g., AM, PSK, PWM, etc., can be used. The typical data rate is a few hundred baud, but any desired data rate can be used.

As indicated by sound waves 22, controller 10 is in two-way communication with power supplies 24a, 24b, . . . 24n, which are typically within a few meters of controller 10. Alternatively, controller 10 can be located within one of supplies 24 (the master) with the remaining supplies 24 being controlled (the slaves). Further, a plurality of supplies 24 (up to all of them) could have controllers 10 with one of controllers 10 being designated the master controller. This designation can be automatic using methods known in the art. Power supplies 24 are optionally mounted within the same rack (not shown) and can have different output current capabilities.

Power supply 24a comprises a transducer 26a, an interface 28a, coupled to transducer 26a, and a converter 30a coupled to interface 28a. In turn, interface 28a can comprise oscillators, modulators, amplifiers, detectors, and a microprocessor (none shown) and all as known in the art. Similarly, power supplies 24b and 24n comprise the same elements with “b” and “n” respectively used as suffixes.

An AC input power bus 32 is coupled to a source of AC power 34 such as the AC mains line, or a local alternator. Bus 32 is also coupled to power supplies 30. If desired, bus 32 can convey DC power from, e.g., a battery or DC generator (neither shown). Further, if desired, converters 30 can be respectively coupled to different AC and/or DC power sources. A DC output power bus 36 is coupled to converters 30 and also to a load, which is represented by a resistor 38. Although power supplies 24 are shown as having their outputs parallel coupled, the outputs can be coupled together in series. Further, power supplies 24 can provide AC power.

If the input power is AC and the output power is DC, then converters 30 can each comprise a transformer, full or half-wave SCR or GTO solid state rectifiers or thyristor vacuum tubes, and a filter (none shown), all as known in the art. The DC output voltage can be controlled by, e.g., pulse width modulating the gate or grid voltage although any other method can be used. If the input power is DC and the output power is DC, then converters 30 can each comprise a voltage inverter circuit (not shown) as known in the art. This can have similar output voltage control as described above. If the input power is AC or DC and the output power is AC, then converters 30 can each comprise an oscillator (not shown) powered by the input power bus 32 and having an optional amplitude control.

In operation, power supplies 24 would transmit identification and data, e.g., output voltage and current, power consumption, power supply failure, etc., to controller 10 for display by display 16. An operator (not shown) views display 16, and if the values are not satisfactory, enters commands on keyboard 12 for transmission back to at least one of the power supplies 24 to correct the problem, e.g., reduce the output current and/or voltage from at least one of supplies 24 so that it is within its rating. Alternatively, the control function can be partially or completely automatic, i.e., without requiring an operator, by methods known in the art. Such automatic operation eliminates the need for keyboard 12 and/or display 16. Also, controller 10 can receive commands from higher level (line or plant level) controllers (not shown) and use these commands to control supplies 24.

While the present invention has been particularly described with respect to preferred embodiments, it will be understood that the invention is not limited to these particular preferred embodiments, the process steps, the sequence, or the final structures depicted in the drawings. On the contrary, it is intended to cover all alternatives, modifications, and equivalents as may be included within the spirit and scope of the invention defined by the appended claims. In addition, other methods and/or devices may be employed in the method and apparatus of the instant invention as claimed with similar results.

What is claimed is:

1. A method of communicating between a plurality of power supplies coupled to a common output power bus and a controller, said method comprising transmitting and receiving sound waves between said controller and said power supplies.

2. The method of claim 1, wherein said sound waves have a frequency of at least 18 KHz.

3. The method of claim 1, further comprising FSK modulating said sound waves.

4. The method of claim 1, further comprising modulating said sound waves with data signals from at least one of said power supplies and command signals from said controller.

5. Apparatus comprising:
a plurality of power supplies coupled to a common output power bus; and
a controller,
each of said power supplies and said controller comprising an interface transmitting and receiving sound waves between said controller and said power supplies for communication therebetween.

6. The apparatus of claim 5, wherein said sound waves have a frequency of at least 18 KHz.

7. The apparatus of claim 5, wherein said sound waves are FSK modulated.

8. The apparatus of claim 5, further comprising a modulator modulating said sound waves with data signals from at least one of said power supplies and command signals from said controller

9. The apparatus of claim 5, further comprising a common input power bus.

10. The apparatus of claim 5, wherein each of said power supplies comprises an AC-to-DC converter.

11. The apparatus of claim 5, wherein said controller is disposed within at least one of said power supplies.

12. The apparatus of claim 5, wherein said controller comprises a display.

13. The apparatus of claim 5, wherein said controller comprises an automatic controller.

14. The apparatus of claim 5, wherein said controller comprises a keyboard.

15. Apparatus comprising:
a plurality of power supplies adapted to be coupled to a common AC input power bus and a common DC output power bus, each of said supplies including an AC-to-DC converter;
a controller;
each of said supplies and said controller comprising an interface transmitting and receiving FSK modulated sound waves of at least 18 KHz frequency between said controller to said supplies for communication of data signals from said supplies to said controller and command signals from said controller to at least one of said supplies.
